(19) United States
(12) Patent Application Publication
(10) Pub. No.: US 2007/0016510 A1
(43) Pub. Date: Jan. 18, 2007

(54) System for matching asset owners and those having interests in the assets

(76) Inventor: Gaurav Pal, Gaithersburg, MD (US)

Correspondence Address: LARRY J. GUFFEY, WORLD TRADE CENER - SUITE 1800, 401 EAST PRATT STREET, BALTIMORE, MD, 21202, US

(21) Appl. No.: 11/183,372

(22) Filed: Jul. 18, 2005

(51) Int. Cl. G06Q 40/00

(52) U.S. Cl. 705/37; 705/35

(57) ABSTRACT

A data gathering and processing method for matching asset owners with those who have interests in providing products or services related to these includes the steps of providing the means for: (a) gathering asset related data, (b) computer processing this data, (c) storing this data, (d) directing the processing means to process the data to compute potential needs and opportunities related to the assets, (e) communicating that allows one to access the gathered data and computed needs and opportunities, and (f) allowing said providers to enter into said storage means a specific offer to provide asset-related services or products to the asset owner.

### BACKGROUND OF THE INVENTION

1. Field of the Invention

This invention relates to data processing and automated, electronic business practices. More particularly, this invention relates to new methods and apparatus for matching asset owners with those who knowingly or unknowingly have business interests in these assets or asset owners.

2. Description of the Related Art

Business owners and many consumers often seek to obtain the greatest return on their assets and investments. When their assets of interest are used to provide services or need routine maintenance, they are often faced with the challenge of how to most efficiently use these assets or provide maintenance for them.

For example, when these assets are commercial vehicles and the issue with respect to them is their maintenance, the challenge can consist of their owners having to order services for their vehicles by opening a telephone book and sifting through numerous listings of repair businesses in order to find the right one. Such an owner looks for a business that will service a specific type of vehicle; one that provides the appropriate type of service, and one that is located in the geographical area desired by the owner. This can be a laborious process as there are an abundant number of repair service businesses listed in most telephone books. In addition, most of these listings have limited information regarding the repair business' qualifications and specialties. Furthermore, while the listings provide street addresses of these businesses, this can often be of limited value if the owner does not know the location of the street given in the listing.

Alternatively, an owner may return to the dealer who sold him or her the vehicle. However, service centers at dealerships can be very expensive in comparison to other service businesses. Therefore, an owner can be left with the choice of selecting an expensive dealership repair facility or searching extensive telephone book listings trying to select an appropriate repair service business.

Recently, through the Internet and World Wide Web (“WWW”), vehicle repair businesses have been able to advertise on websites and through various search engines. These search engines provide a number of directories containing various categories of vehicle services. Some of these on-line services even provide listings of service providers with respect to a certain location. Unfortunately, an owner is still left to call the repair business, find out if an estimate is available over the phone, describe the problem, and schedule an appointment. Moreover, this process must be repeated for each suitable repair business in the area. This is very time consuming and will likely be a frustrating experience for most owners.

What is needed for this and many other types of assets is a process and system that will allow an asset owner to simply and efficiently provide the required services (e.g., maintenance) for their assets. Ideally, this process should timely match those who seek to provide such services with those asset owners who just happen to currently be in need of such services.

Similarly, when the issue is the optimal use of specific assets (e.g., a trucking business that deplores having empty trucks returning from distant locations), the asset owner needs a process that will timely match the routes of his/her otherwise empty trucks with those needing shipping or trucking services along such routes.

3. Objects and Advantages

There has been summarized above, rather broadly, the prior art that is related to the present invention in order that the context of the present invention may be better understood and appreciated. In this regard, it is instructive to also consider the objects and advantages of the present invention.

It is an object of the present invention to provide a method and apparatus for matching, for the economic betterment of all, asset owners with those who knowingly or unknowingly have business interests in these assets.

When these assets are vehicles in need of maintenance, it is an object of the present invention to provide a method and apparatus for timely matching, for the economic betterment of all, the vehicle owners with those who can provide such maintenance services.

When these assets are the vehicles in a commercial trucking fleet and the objective is to ensure that they move on the roads as much as possible in a fully loaded condition, it is an object of the present invention to provide a method and apparatus for timely matching, for the economic betterment of all, such fleet owners with those who are in need of such trucking services.

These and other objects and advantages of the present invention will become readily apparent as the invention is better understood by reference to the accompanying summary, drawings and the detailed description that follows.

### SUMMARY OF THE INVENTION

Recognizing the need for the development of improved methods and apparatus for matching, for the economic benefit of all, asset owners with those who knowingly or unknowingly have business interests in these assets, the present invention is generally directed to satisfying the needs set forth above and overcoming the disadvantages identified with prior art methods and apparatuses.

In accordance with the present invention, the foregoing need can be satisfied by providing a data gathering and processing system for matching asset owners with those who have interests in these assets (including those who could provide products or services related to the assets and those who could have an interest in using, researching, buying or selling the assets), with this system including: (a) a means for gathering data related to the assets, assets owners and those having interests in the assets, (b) a means for computer processing this data, (c) a means for storing this data, (d) a means for processing this data to compute potential needs and opportunities related to the assets, (e) a means for processing the data to compute parameters related to the state of the assets, and (f) a means for providing a graphical user interface that allows one to view information related to the computed needs and parameters.

In another preferred embodiment, this system further includes: (g) a means for matching the computed needs and opportunities with those having interests in the assets, (h) a means for communicating the matches to the asset owners and those having interests in the assets, and (i) a means for allowing one having been so matched to communicate to the asset owner an offer to address this need or opportunity.

In accordance with another preferred embodiment of the present invention, a data gathering and processing method for matching asset owners with those who have interests in providing products or services related to these includes the steps of providing the means for: (a) gathering asset related data, (b) computer processing this data, (c) storing this data, (d) directing the processing means to process the data to compute potential needs and opportunities related to the assets, (e) communicating that allows one to access the gathered data and computed needs and opportunities, and (f) allowing said providers to enter into said storage means a specific offer to provide asset-related services or products to the asset owner.

Additionally, the present invention can take the form of a computer program product in a computer readable memory for controlling a processor that can achieve each of the process steps listed in the above method.

Thus, there has been summarized above, rather broadly, the present invention in order that the detailed description that follows may be better understood and appreciated. There are, of course, additional features of the invention that will be described hereinafter and which will form the subject matter of the claims to this invention.

### BRIEF DESCRIPTION OF THE DRAWINGS

FIG. 1 illustrates some of the various components and system users who are involved in interactions with a preferred embodiment of the present invention.

FIG. 2 illustrates some of the possible tracking means for mobile assets and the related communication equipment that can be utilized as part of the present invention.

FIG. 3 displays a representative a data table within the database of a preferred embodiment of the present invention.

FIG. 4 displays another type of representative data table that might be found within the database of a preferred embodiment of the present invention.

FIG. 5 illustrates how some tasks are conducted within of the “business match matchmaking” services of a preferred embodiment of the present invention.

### DESCRIPTION OF THE PREFERRED EMBODIMENT

Before explaining at least one embodiment of the present invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The present invention in its very simplest form should be recognized to be a business process in which information is gathered about various types of assets (e.g., both mobile and static) and then, after appropriately processing the information, certain details gained from this processing (e.g., derived potential future needs of the asset) are made available to interested users (including the asset owner and certain third-parties—typically providers of services and products to the owner of the assets) so as to provide a match-making method and means for most effectively and efficiently increasing the return that can be achieved by the utilization of such assets.

In a preferred embodiment of the present invention, a central server 10 is used to record information related to the assets of interest. For example, for a mobile asset (e.g., a commercial truck) a tracking device 12 can be attached to the mobile asset 2 so as to wirelessly record and transmit (i.e., using GPS and GSM, CDMA, WiMAX, or WiFi technologies) at selected instances certain information 14 about the asset (e.g., its location, speed, direction).

The central server has a storage device 16 which allows this information to be stored. It also has a graphical user interface (GUI) 18 that allows interested parties (e.g., the asset-owner 4) to view all or part of the collected information or data. The central server also has a processor 20 that allows for various computations to be made using the collected data. Appropriately written software 22 is run on the processor so as to, among other things, compute various pieces of information (e.g., for a commercial truck: tire mileage, mileage since last oil change, predicted time until next mileage-based maintenance services will be needed, expected excess hauling capacity on the next leg of the truck's planned route) that could be of interest to potential service and product providers 6 (e.g., transportation brokers, insurance agents, tax & accounting service providers, truck maintenance service providers). A portion 22a of this software can also provide the appropriate interfaces and direct any one of a number of communication means 24 so as to allow these potential providers to offer, in response to the computed information provided them by the server's data processing activities, services and products to the asset owner.

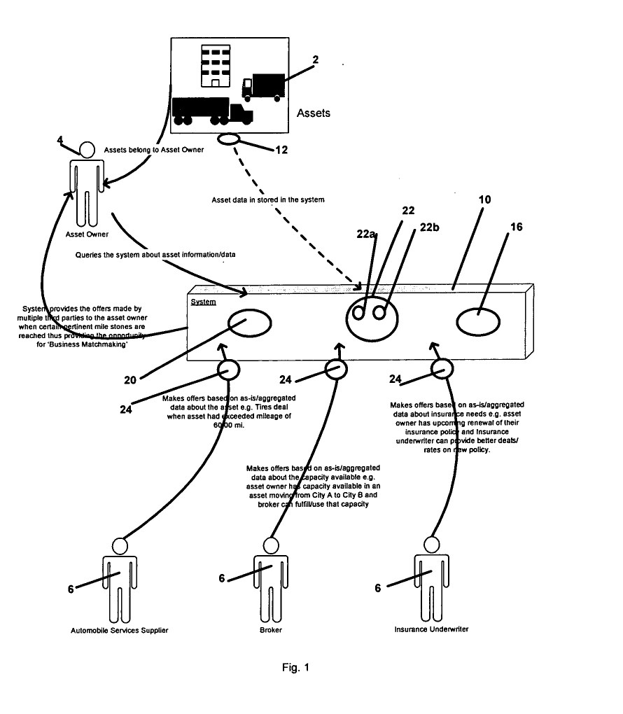

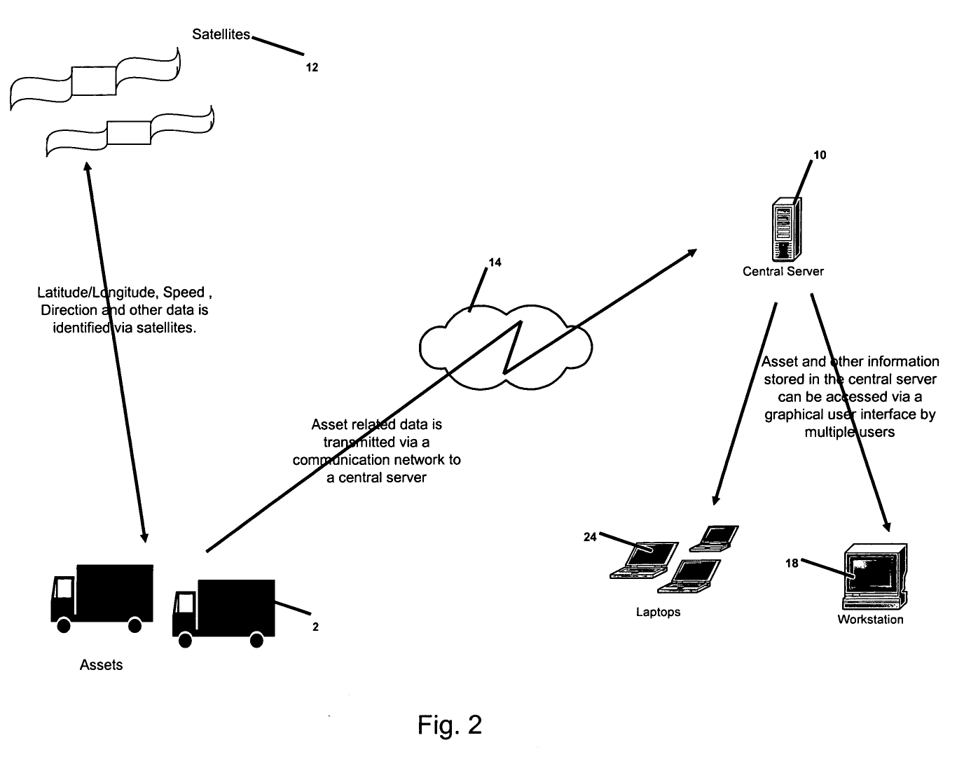

Alternatively, a further portion 22b of the software that drives this system can be written so as to match the quasi-permanent offerings of the providers to the predicted needs of the assets and to inform the asset-owner as to when he/she should address a predicted need of the asset and who among the possible providers is most likely able to be able to meet, accordingly to selection criteria provided by the asset-owner, this need of the asset. The present invention is thus seen to effectively aid in performing a business match-making service. See FIGS. 1 and 2.

FIG. 1 illustrates the various actors who are involved in interactions with the system. These include the assets 2, which belong to the asset owner 4. Information 14 related to the assets is stored in the system and the asset owner can query the system to review information, messages and offers related to his or her asset. An automobile services supplier, a trucking broker and an insurance underwriter are examples of suppliers 6 who may choose to make offers based on the information and its computed results that are stored in the system. The system can store the data on offers available and display them to the asset owner when the appropriate milestone is achieved, thus providing opportunities for business match making

FIG. 2 displays one of the possible basic tracking mechanism of the system. Using satellites 12, the location of assets 2 is captured. In addition to location information, other information parameters like speed and distance traveled are also captured. All this information is then transmitted, preferably wirelessly, via the communication infrastructure to the main system database of the central server. The system then processes the information and provides these results to various asset/business owners where they can view related information via GUI screens 18.

A special advantage of this embodiment is the broad categories and subcategories of asset-related needs and opportunities that can be addressed by the present invention. For the example of a commercial truck, these may include: vehicle maintenance related services, insurance services required by the asset, and accounting and tax related services associated with computing and controlling the operational costs/profits of the truck. See FIGS. 2-5.

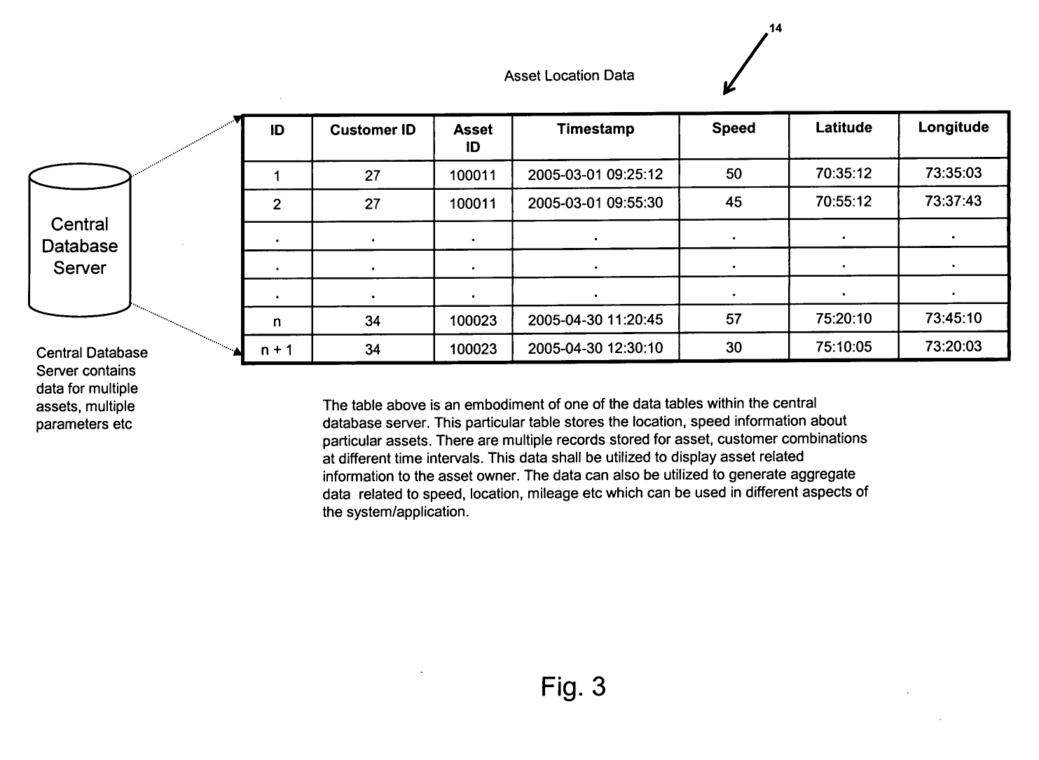

FIG. 3 displays a representative data table within the central server database which stores some of the data which is retrieved from the tracking system and other sources. This data table contains information about the customer, the asset, the date and time when a particular speed was recorded for a mobile asset. Such a data table can also have information on total miles driven during a particular trip for an asset. Such data tables can also have multiple records for various combinations of customers, assets and date times. This data is used by the system to process and display information to the asset/business owner, which is turns helps the business owner in organizing, planning and implementing different areas of his business.

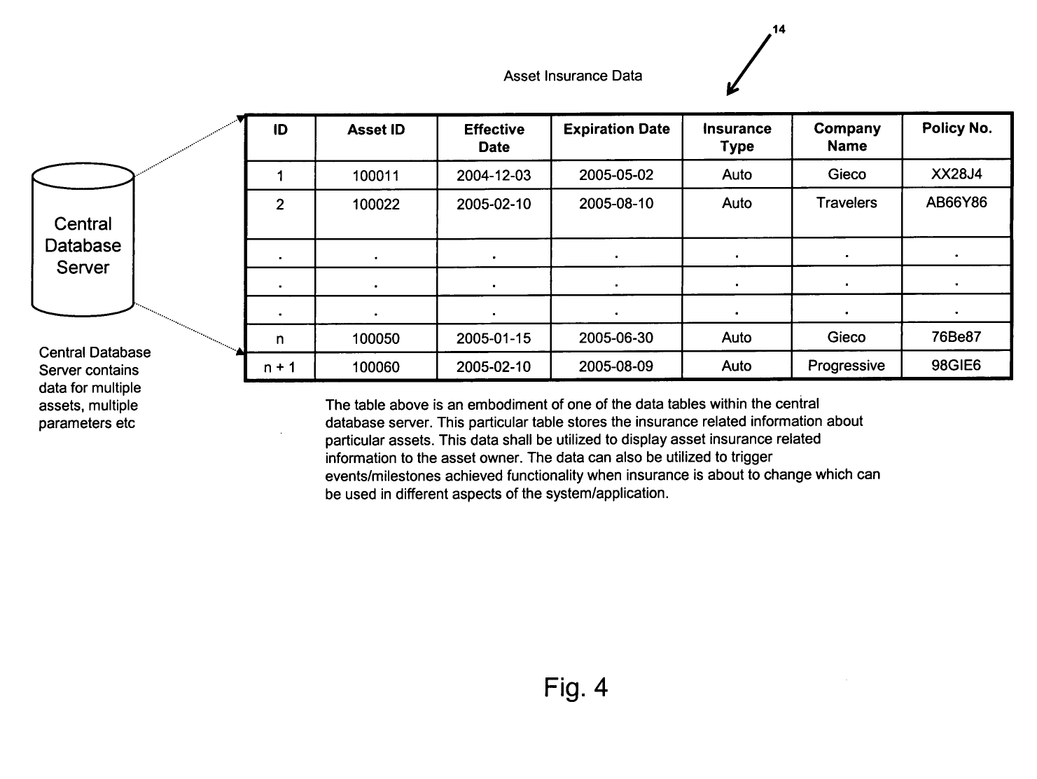

FIG. 4 is a representation of another possible table within the central server database. This table stores background information related to asset (e.g., the asset's insurance information: the effective date of the insurance, the expiration date of the insurance, the type of insurance). Such a data table can have multiple records for an asset which, together other related information, can help an asset/business owner make decisions about the asset's insurance dealings, etc.

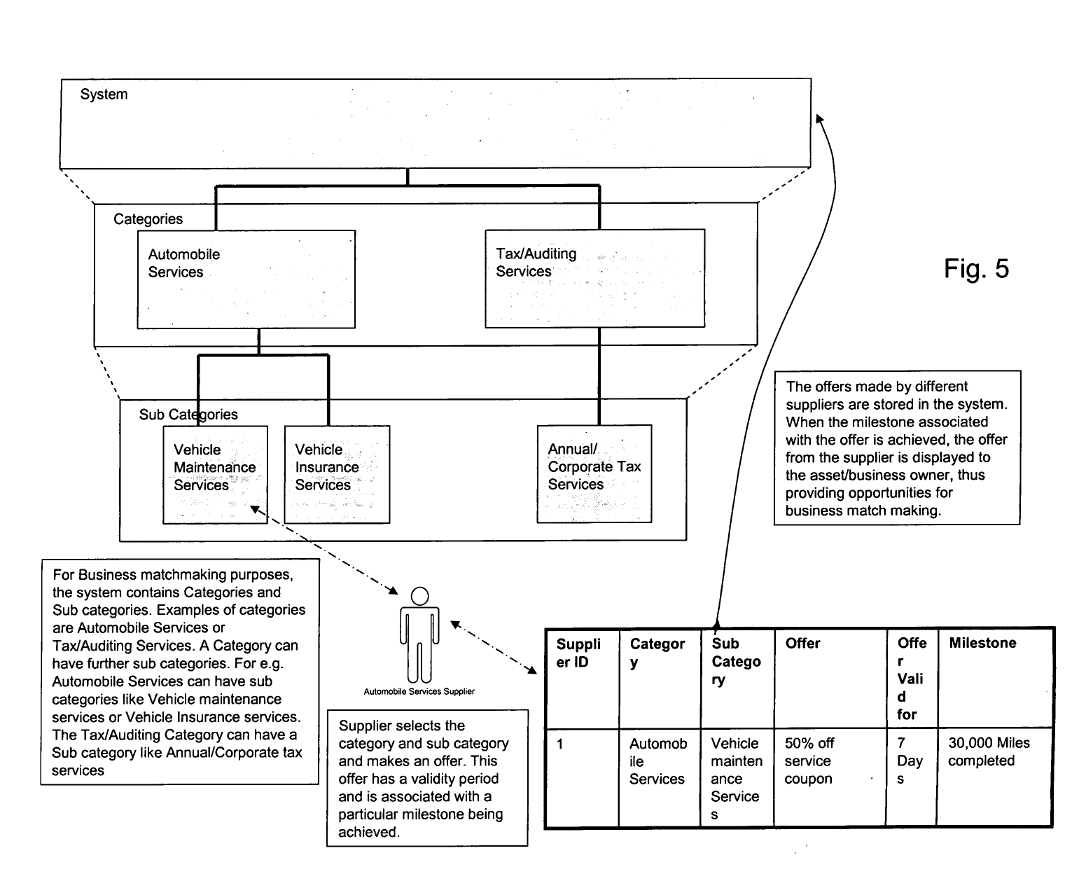

FIG. 5 attempts to illustrate how some tasks are conducted within of the “business match matchmaking” services of a preferred embodiment of the present invention. The system can provide a supplier, who registers with the system to, at some later date, consider providing a specific type of offer for services or products, with various categories and sub categories of information that can be helpful in assisting the registered provider to prepare and submit a bit to offer assorted, asset-driven services to an asset owner. A supplier can pick multiple categories and sub-categories within which they would like to make offers to the asset/business owners. Examples of such categories could be “Automobile Services (e.g., Maintenance, Insurance)” or “Tax/Auditing Related Services. The system presents the opportunity for business matchmaking to the asset/business owners when certain milestones related to the various categories are achieved. The system processes information within the central server and determine when a particular milestone has been reached. When the milestone is reached and if milestone is associated with a specific type of offer within the system, the system can identify the appropriate registered providers and notify them that now would be the timely instance at which to make a specific offer. Additionally, the system can display the offer/message from this supplier to the asset/business owner to implement “business matchmaking.”

To further illustrate various embodiments of the present invention, given below is a stepwise discussion of how the primary components of such embodiments might interact in specific, potential applications of the present invention.

Application A—The asset owner is a “captive” vehicle fleet owner who uses the fleet to carry out his own business as opposed to hiring out his fleet for profit:

A1—A van with a tracking device transmits location co-ordinates (latitude & longitude), speed, direction, time and ID information to a designated Computer System.

A2—The Computer System receives transmission and records asset identifier, location data and time of transmission and the other useful information parameters.

A3—The Computer System aggregates such information over time and determines that a mileage dependent service-maintenance is required for the van.

A4—The Computer System searches for interested potential providers or third-parties that have registered on the System looking to provide service-maintenance services to this business.

A5—At the appropriate time, as determined by the Systems' knowledge of certain maintenance milestones and its own computations based on the collected data of when the milestones will be achieved, the asset owner is shown details of the System's registered outstanding, service-maintenance offers.

Application B—The asset owner is a “for-hire” truck fleet owner who uses the fleet to provide transportation services for profit:

B1—The asset owner logs into Computer System and records details of an upcoming truck trip to transport material for a customer. Information recorded includes material to be transported and destination city amongst others.

B2—A truck with tracking device transmits location co-ordinates and other information parameters to the Computer System.

B3—The Computer System receives transmission and records asset identifier, location data, time of transmission and other information parameters.

B4—The Computer System matches asset ID with trip details recorded earlier by the asset owner and determines if the truck has reached its destination city.

B5—The Computer System searches for interested third-parties (e.g., a shipping broker that has registered on the system looking to buy transportation services).

B6—The asset owner is shown details of outstanding offers that are registered in the System to buy various transportation services.

Application C—How a third-party, maintenance service provider interacts with the System:

C1—A third-party uses the Computer System to select business categories and sub-categories within which they would like to make offers to the asset owner. The information recorded includes geographical region, time duration of offer, etc.

C2—Within each category, the third-party feeds information about the actual offer they would like to provide to the asset owner and the milestones at which they would like to make these offers.

C3—The Computer System records information related to the assets of interest (e.g., the mileage of the trucks of a fleet owner who is also a System subscriber). This information can either be entered by the fleet owner or automatically recorded through a tracking device installed on the truck(s).

C4—The Computer System determines, based on the known service-schedule for a particular make of truck(s), that a service-maintenance is required by looking at the truck's recorded mileage.

C5—The Computer System then searches for all third-parties interested in providing truck maintenance services within the geographic area within which the trucks operate. The Computer System also ensures all of such identified offers have valid offer dates.

C6—The Computer System then provides the asset owner with an alert/notification or some other form of indication about the third-party's offer.

Application D—How a third-party, insurance service provider interacts with the System.

D1—A third-party uses the Computer System to select business categories and sub-categories within which they would like to make offers to the asset owner (which in this case would be insurance services). The information recorded includes geographical region, time duration of offer, etc.

D2—The Computer System records information related to assets (e.g., the expiration date of their existing insurance). This information would have been previously entered by the fleet owner in the System or in some other form made available to the System (e.g., a systemic interface to another system).

D3—Once the expiration date of the existing insurance on a fleet (or truck) is imminent, the Computer System then searches for all third-parties interested in providing insurance services within the geographic area within which the trucks operate. The Computer System ensures that identified outstanding offers have a valid offer date.

D4—The Computer System then provides the asset owner with an alert/notification or some other form of indication about the identified third-partiess offers.

It should be noted the foregoing is considered as illustrative only of the principles of the present invention. Further, since numerous modifications and changes will readily occur to those skilled in the art, and because of the wide extent of the teachings disclosed herein, the foregoing disclosure should not be considered to limit the invention to the exact construction and operation shown and described herein. Accordingly, all suitable modifications and equivalents of the present disclosure may be resorted to and still considered to fall within the scope of the invention as hereinafter set forth in the claims.

I claim:

1. A data gathering and processing system for matching asset owners with those who have interests in said assets including those who could provide products or services related to said assets and those who could have an interest in using, researching, buying or selling said assets, said system comprising:
a means for gathering data related to said assets, said assets owners and those having interests in said assets,
a means for computer processing said data,
a means for storing said data,
a means for directing said processing means to process said data to compute potential needs and opportunities related to said assets, and
a means for communicating that allows one to access said gathered data and computed needs and opportunities.

2. The system as recited in claim 1 further comprising:
a means for allowing said providers to enter into said system a specific offer to provide asset-related services or products to said asset owner.

3. The system as recited in claim 1 further comprising:
a means for allowing said ones interested in using, buying or selling said assets to enter into said system a specific offer to use, buy or sell said assets.

4. The system as recited in claim 1 further comprising:
a means for directing said processing means to process said data to compute parameters related to the state of said assets.

5. The system as recited in claim 4 further comprising:
a means for allowing said providers to enter into said system a specific offer to provide asset-related services or products to said asset owner.

6. The system as recited in claim 4 further comprising:
a means for allowing said ones interested in using, buying or selling said assets to enter into said system a specific offer to use, buy or sell said assets.

7. The system as recited in claim 5 further comprising:
a means for directing said processing means to match said computed needs and opportunities with said offers of said providers.

8. The system as recited in claim 6 further comprising:
a means for directing said processing means to match said computed needs and opportunities with said offers of said ones interested in using, buying or selling said assets.

9. The system as recited in claim 7 further comprising:
a means for using said computed state parameters to trigger a communication to said asset owner as to when it would be appropriate for said asset owner to consider one of said outstanding offers in said system.

10. The system as recited in claim 8 further comprising:
a means for using said computed state parameters to trigger a communication to said asset owner as to when it would be appropriate for said asset owner to consider one of said outstanding offers in said system.

11. The system as recited in claim 4 further comprising:
a means for allowing said providers to register with said system to provide at some later date an offer to provide a specific type of asset-related services or products to said asset owner.

12. The system as recited in claim 4 further comprising:
a means for allowing said ones interested in using, buying or selling said assets to register with said system to provide at some later date a specific type of offer to use, buy or sell said assets.

13. The system as recited in claim 11 further comprising:
a means for directing said processing means to match said computed needs and opportunities with said types of offers of said providers.

14. The system as recited in claim 12 further comprising:
a means for directing said processing means to match said computed needs and opportunities with said specific type of offers of said ones interested in using, buying or selling said assets.

15. The system as recited in claim 13 further comprising:
a means for using said computed state parameters to trigger a communication to one of said registered providers as to when it would be appropriate for said provider to consider entering into said system a specific offer.

16. The system as recited in claim 14 further comprising:
a means for using said computed state parameters to trigger a communication to one of said registered ones interested in using, buying or selling said assets as to when it would be appropriate for said one to consider entering into said system a specific offer.

17. A data gathering and processing method for matching asset owners with those who have interests in said assets including those who could provide products or services related to said assets and those who could have an interest in using, researching, buying or selling said assets, said method comprising the steps of:
providing a means for gathering data related to said assets, said assets owners and those having interests in said assets,
providing a means for computer processing said data,
providing a means for storing said data,
providing a means for directing said processing means to process said data to compute potential needs and opportunities related to said assets, and
providing a means for communicating that allows one to access said gathered data and computed needs and opportunities.

18. The method as recited in claim 17 further comprising the step of:
providing a means for allowing said providers to enter into said storage means a specific offer to provide asset-related services or products to said asset owner.

19. The method as recited in claim 17 further comprising the step of:
providing a means for allowing said ones interested in using, buying or selling said assets to enter into said storage means a specific offer to use, buy or sell said assets.

20. The method as recited in claim 18 further comprising the step of:
providing a means for directing said processing means to match said computed needs and opportunities with said offers of said providers.

21. The method as recited in claim 19 further comprising the step of:
providing a means for directing said processing means to match said computed needs and opportunities with said offers of said ones interested in using, buying or selling said assets.
